(19) United States
(12) Patent Application Publication
(10) Pub. No.: US 2007/0038511 A1
(43) Pub. Date: Feb. 15, 2007

(54) Combined search engine and consumer incentive advertising system and method

(76) Inventor: David Hytken, San Diego, CA (US)

Correspondence Address: Lorraine M. Donaldson;#610, 1927 Harbor Boulevard, Costa Mesa, CA, 92627, US

(21) Appl. No.: 11/202,621

(22) Filed: Aug. 12, 2005

(51) Int. Cl. G06Q 30/00

(52) U.S. Cl. 705/14

(57) ABSTRACT

A combined advertising search engine and consumer incentive system which allows an account holder to accrue awards points for selecting an advertiser listing among a search results list and for making purchases within the system and later redeeming said awards points for products or services. The system also provides convenience for a business owner to enroll both a consumer and an advertising merchant, to accrue awards points for business purchases, and to redeem said accrued points for business related purchases, thereby reducing operating costs.

### BACKGROUND OF THE INVENTION

1. Field of the Invention

The invention relates to a search engine which rewards consumers for selecting an enrolled advertiser listing among a search results list and/or for making purchases through the system.

2. Description of Related Art

A number of Internet websites, namely search engine websites, provide visitors with the capability to search for Internet listings on a particular topic, and provide advertising services to those wishing to appear on a search results list for at least one topic. Some search engines may also a visitor to make purchases or travel reservations through corresponding links in the search engine host site. However, current search engines rely mainly in the proposed convenience of searching and shopping in a single site or by offering competing prices, but fail to provide loyalty incentives for repeat visitors.

Additionally, some credit card companies and travel merchants such as airlines and hotel chains use incentive programs which awards customers with points or miles for every purchase. Said points or miles can later be redeemed with the issuing merchant in exchange for products, services or credits in the customer's account. For example, a credit card may allow a customer to accumulate a “cash-back bonus” corresponding to a percentage of every qualifying purchase made with the credit card account and to later exchange said “cash-back bonus” for a currency amount in the form of a credit in the account balance. In the case of an airline or hotel chain, the customer may be awarded a predetermined amount of points or miles for each qualifying reservation and, when sufficient points or miles are accumulated, redeem them for a new reservation or a product offered by an affiliate merchant. However, the selection of services or products to be redeemed in these incentive programs is usually limited to transactions with the merchant issuing said award points or specific items previously negotiated by said merchant with affiliate merchants.

The present invention presents a combined search engine system and customer incentive program which solves the aforementioned problems by rewarding repeat visitors of the search engine and offering a vast range of products or services to be redeemed in exchange for accrued awards points. Moreover, the system also offers merchants the flexibility of holding a membership account both as a consumer and as an advertising merchant.

Other benefits of the present invention is the ease of use and increasing selection of products and services to be redeemed for awards points, as new merchants enroll in the system.

### BRIEF SUMMARY OF THE INVENTION

The present invention comprises, as illustrated in FIG. 1, a combined advertising search engine and consumer incentive system 10 including a Membership Account Module 12 which allows visitors to the host website to create and manage a membership account; a Query Processing Module 14 which allows a user to submit different types of queries to the system and which displays, in return, a query results list for review by the user; and a Shopping and Rewards module 16 which manages transactions processed through the shopping site and the rewards site of the system, billing for purchases, assigning awards points to a membership account for actions on the system and processing requests to redeem accrued awards in the system 10.

As illustrated in FIG. 3, the Membership Account Module 12 includes an Account Information Module 22, a Merchant Parameters Module 24, a Balance Tracking Module 26 and a Log-In Module 24.

As shown in FIG. 4, the Query Processing Module 14 includes an Internet Listing Module 32, a Shopping Query Module 34, a Featured Deals Query Module 36, and a Rewards Query Module 38. Correspondingly, the types of queries processed by this module may include either of a search query for Internet listings including advertiser merchants on the host website, a product or service related search in a shopping site of the system 10, or a reward search in a rewards site of the system 10.

The Shopping and Rewards Module 16, illustrated in FIG. 5, includes a Purchase Processing Module 42, an Awards Points Issuing Module 44, a Points-to-Currency Module 46 and a Reward Redeeming Module 48.

The present invention further comprises a method of using the combined search engine and consumer incentive system.

### BRIEF DESCRIPTION OF THE DRAWINGS

The present invention is described in detail below with reference to the drawings in which:

FIG. 1 shows the main components of the search engine system of the present invention.

FIG. 2 shows an exemplary embodiment of the user interface for the search engine system.

FIG. 3 shows in further detail the features in the membership account module.

FIG. 4 shows in further detail the features in the query processing module.

FIG. 5 shows in further detail the features in the shopping and rewards module.

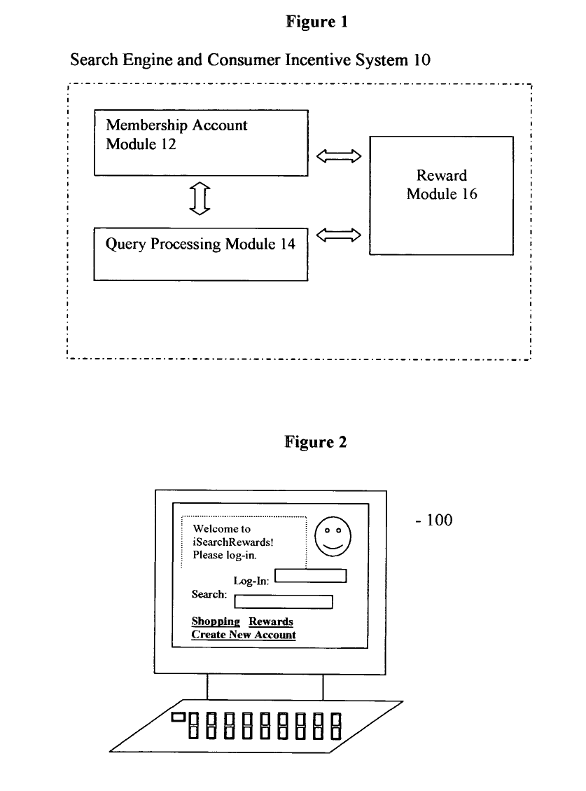

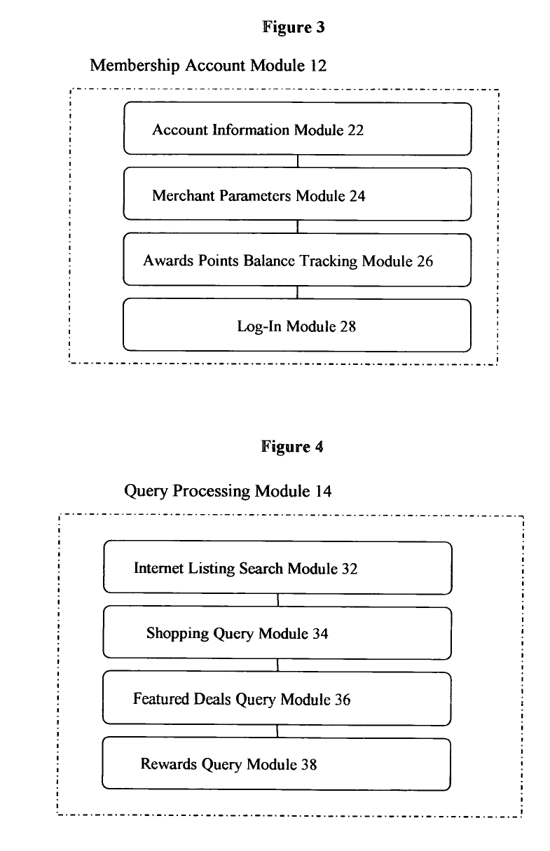

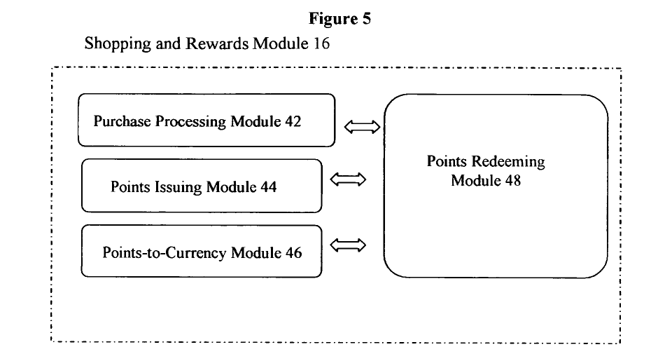

### DETAILED DESCRIPTION OF THE PREFERRED EMBODIMENTS

The search engine system 10 of the present invention comprises a Membership Account Module 12, a Query Processing Module 14 and a Shopping and Rewards Module 16, which are interconnected to operate a consumer incentive program. The features and operation of each module will be described in detail below.

FIG. 2 shows an exemplary embodiment of an interface for the search engine of the present invention. A visitor can access the host website on their computer 100 through an internet navigator application, such as Netscape Navigator® or Microsoft Internet Explorer®. The exemplary Internet website address for the host website of the present system is “http://www.ISearchRewards.com”.

A visitor interested in searching Internet listings for a particular topic on the host website of the system 10 may simply type a search query in the appropriate text box. The Query Processing Module 14 will filter relevant terms in said search query and select, among the listings of enrolled advertiser merchants, any listings related to the selected relevant search query terms. The visitor may also use the “Shopping” link on the host website to submit a product or service related query and make purchases through the system 10.

However, in order to participate in the consumer incentive program and accrue awards points for using the system, the visitor must become an enrolled member of the system 10. The visitor may create a membership account using the “Create New Account” link on the host website and providing membership account information to the Account Information Module 22, including:
i) name of membership account holder;
ii) mailing address;
iii) contact telephone number; and
iv) e-mail address of account holder.

The Membership Account Module 12 provides the flexibility for a membership account to be created by an advertiser merchant by simply activating merchant parameters in the membership account and payment of an enrollment fee based on said merchant parameters. In the case of an account held by an individual, merchant parameters remain inactive and the account is created fee of charge.

The account holder of a membership account held by an advertiser merchant must be a person authorized to make transactions in the system on behalf of the merchant. Transactions may include providing merchant parameters for the membership account, making business related purchases in the system 10, redeeming awards points accrued by said membership account on behalf of the merchant and the like.

Merchant parameters are activating by providing to the Merchant Parameters Module 24, in addition to the above described membership account information, the following information:
i) company name;
ii) billing address;
iii) selected search query terms associated with the listing for this advertiser merchant;
iv) a short text message containing advertiser information such as a general description of the products and/or services provided by the merchant, stored as the listing information;
v) website address associated with said listing;
vi) selected length of enrollment;
vii) selected ranking on corresponding search listing;
viii) payment information;
ix) selected quantity of awards points to be issued for browsing on listing website address;
x) inventory list of products and/or services to be stored and displayed in said shopping module;
xi) selected quantity of awards points to be issued for a completed purchase transaction in said shopping module; and
xii) featured deals to be stored and displayed in said shopping module.

Once a membership account is created, account is assigned an account identification and password by the Membership Account Module 12. The identification and password will be retrieved and validated by Log-In Module 28 to authorize access to the system 10.

An advertiser merchant may adjust the amount of awards points to be assigned for a purchase in their website at any time, to effectively compete with other merchants offering similar products or services.

The operation of the Query Processing Module 14 will be further described. As any visitor, an enrolled member interested in searching Internet listings for a particular topic on the host website of the system 10 may simply type a search query in the appropriate text box. The Internet Listing Module 32 will filter relevant terms in said search query and select, among the listings among enrolled advertiser merchants, any advertiser listings related to the selected relevant search query terms and determine the order in which the listings will be presented based on the selected ranking of said advertiser listings. The Query Processing Module 14 retrieves and displays the search results list on the host website of the system 10. An enrolled user earns awards points when selecting a search results listing to browse the advertiser merchant website, said points being assigned to the corresponding membership account by the Awards Points Issuing Module 44.

In addition to listing information pertaining to enrolled advertiser merchants, the system may include a general database including non-affiliated website listings i.e., non-profit organizations, religious organizations, government agencies and emergency personnel. The system 10 will, by default, assign a higher priority to enrolled advertiser merchants when displaying a search results list. However, in the absence of registered advertisers to comply with a search query submitted by a user, the Query Processing Module 14 will select relevant non-affiliated website listings to be presented in the search results list.

The query processing module 14 may be further configured to sort listings by geographical location, and the search engine interface may be provided with an option for adding a geographical parameter to a search query in order to allow a search engine user to narrow down a search results list using this parameter, if so desired. This further allows an advertiser to customize their account to be classified in the search engine system as a local, national, and global listing. Additional parameters may be used to sort listings and thereby allow a search engine user to narrow down a search results list.

Using the “Shopping” link on the host website transfers the user to a site administered by the Shopping and Rewards Module 16. A user may type a product or service related query in the appropriate text box. The Shopping Query Module 34 will then filter relevant terms in said query and select, among the products and services of enrolled advertiser merchants, any products or services related to the relevant query terms and determine the order in which the listings will be presented based on the selected ranking for each advertiser merchant. The Query Processing Module 14 retrieves and displays the results list on the site. Each item on the results list is accompanied by an indication of the number of points to be earned by purchasing that particular product or service, as designated by the corresponding advertiser merchant. The Query Processing Module 14 may further select among featured deals of enrolled advertiser merchants, any deals related to the search query and display said deals along with said results lists. The enrolled member earns awards points when completing a purchase from the results lists, and said points are assigned to the corresponding membership account by the Awards Points Issuing Module 44. The functions of billing a purchase and coordinating the delivery of a product, when appropriate, are performed by the Purchase Processing Module 42.

The system 10 may feature a vast range of products depending on the advertiser merchants enrolled in the system including, but not limited to: clothing, furniture, electronics, books, videos, music, toys, cosmetics, and other items.

Moreover, the system may feature a range of services depending on the advertiser merchants enrolled in the system including, but not limited to: mortgages and loans, travel reservations, job placement services, moving services, etc. In this case, an enrolled member earns awards points by completing a request for a particular service, such as filling out a mortgage application or making a travel reservation through the system.

Awards points earned by each membership account are stored by the Balance Tracking Module 26 of the Membership Account Module 12. The Balance Tracking Module 26 will add points issued by the Award Points Issuing Module 44 to any previous balance and will subtract points when a reward is redeemed.

An enrolled member may redeem accrued awards points in two different ways. Using the “Rewards” link on the host website will transfer the user to another site administered by the Shopping and Rewards Module 16. A user may then type a reward related query in the appropriate text box. The Rewards Query Module 36 will then filter relevant terms in said query and select, among rewards established by the system 10, any rewards related to the relevant query terms. The Query Processing Module 14 retrieves and displays the results list on the site. For example, the user may type “flowers” in the text box and review the resulting list of rewards that involve floral arrangements or any item including the term “flower” in the description. Each item on the results list is accompanied by an indication of the number of points required to request said reward, as designated by the System 10. The Reward Redemption Module 48, similar to the Purchase Processing Module 42 described above, will process the exchange of a corresponding amount of awards points for the selected reward and coordinating the delivery of said reward, when appropriate. The second way of redeeming awards points is to type the phrase “shopping certificate” in the text box. The Rewards Query Module 38 will return a list of shopping certificates of different currency value, accompanied by the amount of awards points required to request each certificate as designated by the Points-to-Currency Module 46. Upon selection of a certificate, the user is given a coupon code for use as form of payment in the “Shopping” link. This allows the account holder to exchange award points for at least a portion of the purchase price of any product or service offered by an advertiser merchant.

It is further noted that for a membership account held by an advertiser merchant, the exchange of awards points for currency to be used within the system allows further flexibility, such as the ability to use exchange awards points towards payment of the enrollment fee.

The system of the present invention preferably uses a fixed-fee based advertising method to determine the enrollment fee as disclosed in related U.S. application Ser. No. ______, incorporated herein by reference. The selected ranking of the listing and length of enrollment must be selected for the advertiser merchant in order to determine the enrollment fee. In the preferred embodiment of the system of the present invention, the ranking is tiered into several levels (L1, L2, L3, L4, and so on), each level corresponding to at least one position in a search results list for a particular search query term. Each ranking level is assigned a base fee for a given period of time, for example a week. For ranking levels consisting of multiple positions, all advertisers within the ranking level will have the same base fee. The total fee accorded to an account will be prorated if the length of registration is shorter than the given period for the base fee and, conversely, will be adjusted if the length of registration is longer than the given period for the base fee.

The total enrollment fee of the account is based upon the selected ranking and total length of registration and includes a quota of awards points to be issued by the system to enrolled members for selecting the advertiser merchant's listing in a search results list or completing a purchase of any product or service from said advertiser member through the system 10. Additional charges for an advertiser merchant correspond to a cost-per-awards point issued after depleting said quota.

In the preferred embodiment, the total fixed fee for the selected registration period will be billed upon registration of the account, and upon renewal of registration. Additional charges incurred by the advertiser merchant will be billed periodically.

After setting up the account, the account holder for the advertiser merchant may sign in at any time using the account identification and password to review or alter the account information. However, changes in the selected search query terms, selected ranking and selected length of registration may result in an adjustment to the total fixed fee for the account and thus require additional funds being paid by the advertiser to the system in order to confirm the changes.

Alternately, the enrollment fee for an advertiser merchant may be set by use of a cost-per-click auctioning method of conventional search engine systems and a fixed cost-per-awards point charge for participating in the consumer incentive program of the system 10.

In order to avoid fraudulent use of the consumer incentive program, such as a merchant depleting the quota of awards points of a competitor by repeatedly visiting the competitors website while logged into the system 10, membership accounts held by advertiser merchants may be precluded from earning awards points for browsing websites, and thereby only earning points when making purchases through the system.

While the present invention has been shown and described herein in what are conceived to be the most practical and preferred embodiments, it is recognized that departures, modifications, adaptations, variations and alterations in the described methods and systems may be made and will be apparent to those skilled in the art of the foregoing description which does not depart from the spirit and scope of the invention which is therefore not to be limited to the details herein.

For this reason, such changes are desired to be included within the scope of the appended claims. The descriptive manner which is employed for setting forth the embodiments should be interpreted as illustrative but not limitative of the full scope of the claims which embrace any and all equivalents thereto.

What is claimed is:

1. A combined advertising search engine and consumer incentive system, comprising:
an enrollment module configured to retrieve and store membership account information including account holder information and merchant account parameters and to assign each membership account an account identification and password;
a log-in module configured to retrieve an account identification and password provided by a user and to authorize access to the system contingent on validation of the combination of said account identification and said password;
a search engine module configured to process a search query consisting of relevant keywords and, in response, to display a search results list;
a shopping module configure to process a product or service related query and, in response, to display a list of related featured deals from enrolled merchants; and
a rewards module configured to issue awards points to a corresponding membership account and to allow redemption of accrued awards points of a membership account in exchange for at least one reward.

2. The system of claim 1, wherein said membership account information includes at least one of the group consisting of:
name of membership account holder;
mailing address;
contact telephone number; and
e-mail address of account holder.

3. The system of claim 1, wherein said merchant parameters include at least one of the group consisting of:
company name;
billing address;
corresponding search query keywords;
listing information;
listing website address;
length of enrollment;
selected ranking on corresponding search listing;
payment information;
products and/or services to be stored and displayed in said shopping module;
selected awards points quantity for browsing said listing website address;
selected awards points quantity for a shopping transaction processed through the system; and
featured deals to be stored and displayed in said shopping module.

4. The system of claim 1, wherein said rewards module assigns said membership account a number of awards points each time said account holder browses a selected listing in said search results list or completes a shopping transaction and subtracts a corresponding number of award points from said membership account each time said account holder completes a request to redeem accrued awards points for at least one reward.

5. The system of claim 4, wherein said at least one reward comprises one of the group consisting of: a product, a service or a shopping certificate corresponding to a predetermined currency amount to be redeemed in said shopping module.

6. The system of claim 1, further wherein, when said membership account is held by and individual, said merchant parameters remain inactive and, when said membership account is held by an advertising merchant, said merchant parameters are active and the account holder is a person authorized to provide said merchant parameters, make purchases and redeem awards points on behalf of said advertising merchant.

7. A method for using a combined advertising search engine and consumer incentives system, comprising:
providing membership account information to an enrollment module, wherein said membership account information includes account holder information and merchant account parameters and, in return, being assigned an account identification and password by said enrollment module;
providing said account identification and password provided to a log-in module configured to authorized access to the system contingent on validation of the combination of said account identification and said password by said log-in module;
submitting a search query to a search engine module, said search query consisting of relevant keywords, and reviewing a search results list displayed by said search query module in response to said query;
submitting a product or service related query to a shopping module, and reviewing a list of related featured deals from enrolled merchants displayed by said shopping module in response to said product or service related query; and
accruing awards points issued by a rewards module to said membership account and subsequently redeeming accrued awards points in exchange for at least one reward.

8. The method of claim 7, wherein said membership account information includes at least one of the group consisting of:
name of membership account holder;
mailing address;
contact telephone number; and
e-mail address of account holder.

9. The method of claim 7, wherein said merchant parameters include at least one of the group consisting of:
company name;
billing address;
corresponding search query keywords;
listing information;
listing website address;
length of enrollment;
selected ranking on corresponding search listing;
payment information;
selected awards points quantity for browsing on listing website address;
products and/or services to be stored and displayed in said shopping module; and
featured deals to be stored and displayed in said shopping module.

10. The method of claim 7, wherein said rewards module allows an account holder to accrue points for browsing a selected listing in said search results list or for completing a shopping purchase and further to redeem accrued awards points for at least one reward.

11. The method of claim 10, wherein said at least one reward comprises one of the group consisting of: a product, a service or a shopping certificate corresponding to a predetermined currency amount to be redeemed in said shopping module.

12. The system of claim 7, further wherein, when said membership account is held by and individual, said merchant parameters remain inactive and, when said membership account is held by an advertising merchant, said merchant parameters are active and the account holder is a person authorized to provide said merchant parameters, make purchases and to redeem awards points on behalf of said advertising merchant.
